(19) United States
(12) Patent Application Publication
(10) Pub. No.: US 2018/0158395 A1
(43) Pub. Date: Jun. 7, 2018

(54) DISPLAY PANEL

(71) Applicant: AU Optronics Corporation, HSIN-CHU (TW)

(72) Inventors: Yi-Hsiang CHANG, HSIN-CHU (TW); Hung-Chi Wang, Hsin-Chu (TW); Ya-Fang Chen, Hsin-Chu (TW)

(21) Appl. No.: 15/611,937

(22) Filed: Jun. 2, 2017

(30) Foreign Application Priority Data
Dec. 2, 2016 (TW) 105140005

(51) Int. Cl. G09G 3/20

(52) U.S. Cl. CPC G09G 3/2092; G09G 2320/0223; G09G 2320/0233; G09G 2300/0426; G09G 2310/0251; G09G 2310/08

(57) ABSTRACT

A display panel includes a substrate, a pixel array and a plurality of driving module. The substrate is defined with a wire area and a active area. The pixel array is disposed in the active area. The driving module is disposed in the wire area. Each driving module is electrically to corresponding and multiple pixels in the pixel array through a plurality of wire. Each driving module receives one of multiple starting signals. Each driving module provides a plurality driving signal to the pixels according to the received driving module. A first wire and a second wire are defined among the wires. The first wire is longer than the second wire. The time delay reference to a reference time point of the driving signal provided to the first wire from the driving module is smaller than the time delay reference to a reference time point of the driving signal provided to the second wire.

### BACKGROUND

### Technical Field

The present invention relates to display panels, and in particular, to display panels whose cable lengths cause a signal delay.

### Related Art

As display technologies develop, resolutions and sizes of display panels increase gradually, and consequently, components in display panels also increase. As components increase, how to perform cabling in limited space, so that components can be connected to right cables and cables do not interfere with each other becomes a big issue of engineers during layout. Moreover, currently, a commonest problem is: A drive integrated circuit (integrated circuit, IC) is connected to multiple rows or multiple columns of pixels by passing through fan out (fan out) cables. However, because lengths of fan out cables between the drive integrated circuit and rows of pixels or columns of pixels are different, signal delays caused by the cables are different. Consequently, a pixel drive time sequence becomes a problem, and may further cause a V block problem in a worse scenario.

### SUMMARY

The present invention aims to provide a display panel, to overcome the problem that signal delays caused by cables are different because lengths of fan out cables are different.

The present invention provides a display panel, where the display panel includes a substrate, a pixel array, and drive modules. The substrate includes a display area and a peripheral cable area. The pixel array is disposed in the display area. The drive modules are located in the peripheral cable area. Each drive module is respectively electrically connected to corresponding multiple pixels in the pixel array by passing through multiple conductors. Each drive module receives one of multiple start signals. The start signals are respectively used to indicate at least one time delay relative to a reference time point. Different drive modules receive different start signals. Each drive module provides multiple drive signals to the pixels according to the received start signal. Conductors electrically connected to the drive module include a first conductor and a second conductor. A length of the first conductor is larger than a length of the second conductor. A time delay, relative to a reference time point, of a drive signal provided by the drive module to the first conductor is less than a time delay, relative to the reference time point, of a drive signal provided by the drive module to the second conductor.

The present invention further provides a display panel, where the display panel includes a substrate, a pixel array, and a drive module. The substrate includes a display area and a peripheral cable area. The pixel array is disposed in the display area. The drive module is located in the peripheral cable area. The drive module is respectively electrically connected to multiple pixels in the pixel array by passing through multiple conductors. The drive module provides multiple drive signals to the pixels according to a start signal. Conductors electrically connected to the drive module include a first conductor, a second conductor, and a third conductor. The second conductor is located between the first conductor and the third conductor. There is a first time difference between a drive signal provided by the drive module to the first conductor and a drive signal provided by the drive module to the second conductor. There is a second time difference between the drive signal provided by the drive module to the second conductor and a drive signal provided by the drive module to the third conductor, and the first time difference is different from the second time difference.

In conclusion, the present invention provides a display panel, where the display panel includes multiple drive modules. Each drive module is respectively electrically connected to multiple pixels in a display area by passing through multiple conductors. Lengths of some conductors are different. The drive modules provide signals having relatively short time delays to relatively long conductors, and provide signals having relatively long time delays to relatively short conductors. In this way, signals that are seen by receive ends, that is, pixels connected to the conductors, have a same time delay, and materials can be updated for each pixel in an intended operation time, to avoid the V block problem.

The foregoing descriptions about content disclosed and the following descriptions about implementation manners are intended to illustrate and explain the spirit and principle of the present invention, and further explain the patent application scope of the present invention.

### BRIEF DESCRIPTION OF THE DRAWINGS

FIG. 1 is a schematic structural diagram of a display panel according to an embodiment of the present invention;

FIG. 2A is a schematic diagram of a transmission time delay in the embodiment shown in FIG. 1 according to the present invention;

FIG. 2B is a schematic diagram of transmission time delays respectively caused by cable segments DF1 to DF5 and cable segments DF1 to DF5 in the embodiment shown in FIG. 1 according to the present invention;

FIG. 3A is a schematic diagram of an initial time delay of each drive signal according to an embodiment of the present invention;

FIG. 3B is a schematic diagram of a total time delay of drive signals according to the embodiment shown in FIG. 3A;

FIG. 4A is a schematic diagram of cables of a display panel according to another embodiment of the present invention;

FIG. 4B is a schematic diagram of initial time delays of drive signals SD1 to SD5 in FIG. 4A;

FIG. 4C is a schematic diagram of initial time delays of drive signals SD6 to SD10 in FIG. 4A;

FIG. 5A is a schematic diagram of cables of a display panel according to still another embodiment of the present invention;

FIG. 5B is a schematic diagram of initial time delays of drive signals SD1 to SD5 in FIG. 5A;

FIG. 5C is a schematic diagram of initial time delays of drive signals SD6 to SD10 in FIG. 5A;

FIG. 6A is a schematic diagram of cables of a display panel according to yet another embodiment of the present invention;

FIG. 6B is a schematic diagram of initial time delays of drive signals SD1 to SD5 in FIG. 6A; and

FIG. 7 is a schematic diagram of a delay of a sweep signal according to an embodiment of the present invention.

### DETAILED DESCRIPTION

In the following implementation manners, detailed characteristics and advantages of the present invention are described in detail. Content thereof can sufficiently enable any person skilled in the art to know and implement technical content of the present invention. Any person skilled in the art can readily understand related objectives and advantages of the present invention according to content disclosed in this specification, the patent application scope, and drawings. Ideas of the present invention are further described in detail in the following embodiments, but are not intended to limit the scope of the present invention.

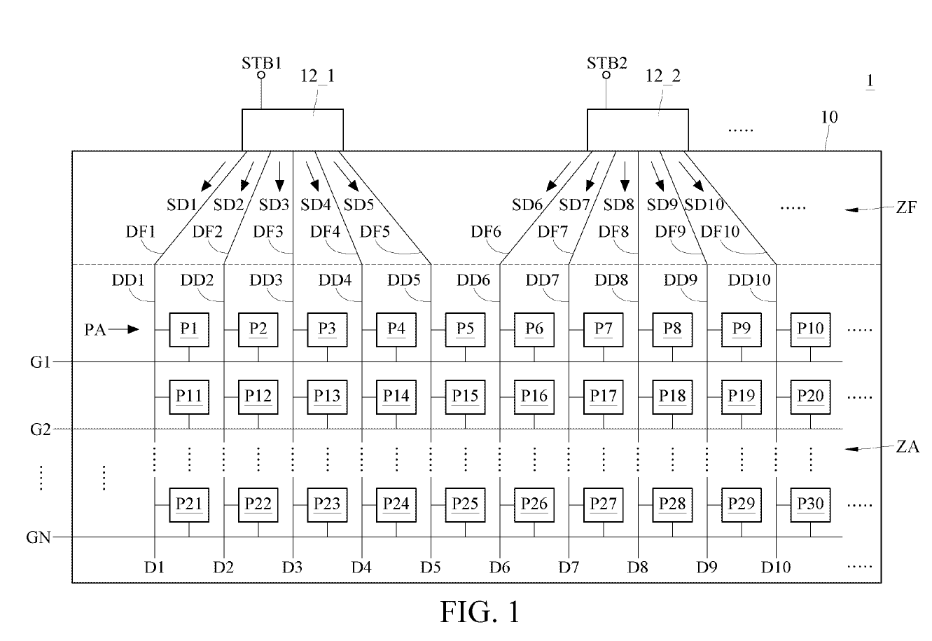

Referring to FIG. 1, FIG. 1 is a schematic structural diagram of a display panel according to an embodiment of the present invention. A display panel 1 includes a substrate10, a pixel array PA, and N drive modules. N is 4 herein, that is, drive modules 12_1 to 12_2 are used as an example for description. The substrate 10 includes a display area ZA and a peripheral cable area ZF. The pixel array PA is disposed in the display area ZA. The drive modules 12_1˜12_2 are located in the peripheral cable area ZF. The pixel array PA includes multiple pixels, and pixels P1 to P30 are used as an example for description herein. Each drive module is respectively electrically connected to the corresponding multiple pixels P1 to P30 in the pixel array PA by passing through multiple conductors. Conductors D1 to D10 are used as an example for description herein. For the conductor D1, the conductor D1 includes a cable segment DF1 and a connection segment DD1. The cable segment DF1 is located in the peripheral cable area ZF, and the connection segment DD1 is located in the display area ZA. One end of the cable segment DF1 is connected to the drive module 12_1, and the other end of the cable segment DF1 is connected to the connection segment DD1. The connection segment DD1 is used to connect to the pixel P1, and the pixel P11 to the pixel P21. From another perspective, the connection segment DD1 is connected to one row of pixels in the pixel array PA.

In this embodiment, the length of the cable segment DF1 is larger than the length of a cable segment DF2, the length of the cable segment DF2 is larger than the length of a cable segment DF3, the length of a cable segment DF5 is larger than the length of a cable segment DF4, and the length of the cable segment DF4 is larger than the length of the cable segment DF3. The length of the cable segment DF1 and the length of the cable segment DF5 may be equal or unequal. In another aspect of the cable segment, in the embodiment shown in FIG. 1, the display panel 1 further includes multiple scanning lines G1 to GN, and the scanning lines G1 to GN are respectively electrically connected to columns of the pixel array PA. For the pixel P1, the pixel P1 is electrically connected to the scanning line G1, the pixel P1 selectively turns on a data write path in the pixel P1 according to an on-cable voltage level of the scanning line G1, and the data write path is electrically connected to the connection segment DD1 of the conductor D1 to receive a drive signal SD1 of the conductor D1. The length of the DF2 and the length of the cable segment DF4 may be equal or unequal.

Each drive module receives one of multiple start signals. Start signals STB1 to STB4 are used as an example for description herein. The start signals STB1 to STB2 are respectively used to indicate at least one time delay relative to a reference time point. Different drive modules receive different start signals. In this embodiment, the drive module12_1 receives the start signalsTB1, and the drive module12_2 receives the start signalsTB2. An analogy may be made below, and details are no longer described. Each drive module provides multiple drive signals to the pixels in the pixel array PA according to the received start signal. In further details, the drive module12_1 respectively provides drive signals SD1 to SD5 to corresponding pixels based on the start signalsTB1 by using the conductors D1 to D5.

In an embodiment, the drive module12_1 is triggered by a negative edge of a pulse of the start signalsTB1, to output the drive signals SD1 to SD5. Correspondingly, in an embodiment, the length of the pulse of the start signalsTB1 is controlled, to control a corresponding time point of the negative edge of the pulse, to control the drive module12_1 to selectively provide the drive signals SD1 to SD5. In another embodiment, the drive module12_1 is triggered by a positive edge of a pulse of the start signalsTB1, to output the drive signals SD1 to SD5. Correspondingly, in another embodiment, a start point of the pulse of the start signalsTB1 is controlled, to control a corresponding time point of the positive edge of the pulse, to control the drive module12_1 to selectively provide the drive signals SD1 to SD5. The foregoing is only for exemplary purpose, and no limitation is imposed thereto.

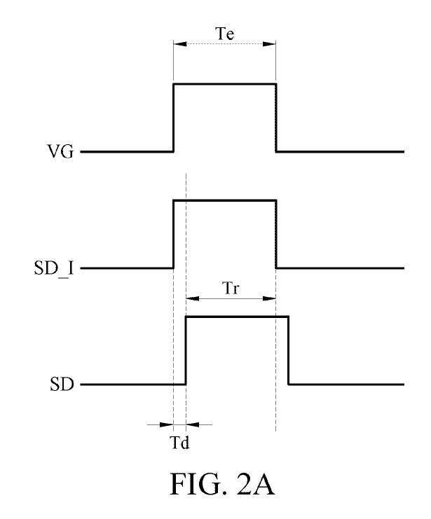

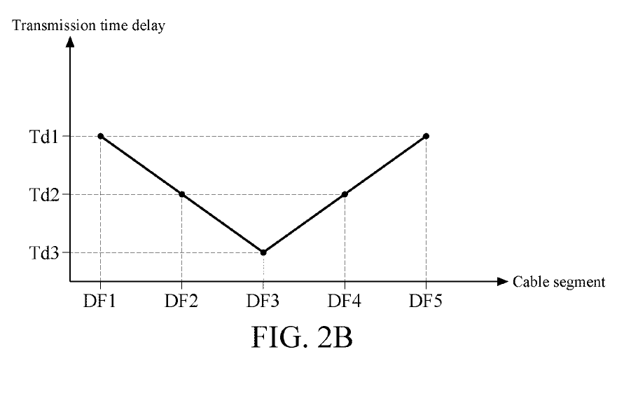

Because the lengths of the cable segment DF1 to the cable segment DF5 are not completely the same, the cable segment DF1 to the cable segment DF5 respectively cause different transmission time delays for the drive signal SD1 to the drive signal SD5. For transmission time delays, refer to both FIG. 2A and FIG. 2B. FIG. 2A is a schematic diagram of a transmission time delay in the embodiment shown in FIG. 1 according to the present invention. FIG. 2B is a schematic diagram of transmission time delays respectively caused by cable segments DF1 to DF5 and cable segments DF1 to DF5 in the embodiment shown in FIG. 1 according to the present invention.

FIG. 2A shows a sweep signal VG on the scanning line G1, an ideal drive signal SD_I transmitted to the scanning line G1, and an actual drive signal SD having a transmission delay. The pulse width of the sweep signal VG is defined as an ideal charging time Te. Only in the ideal charging time Te, the drive signal SD can effectively charge a pixel corresponding to the sweep signal VG. Specifically, from another perspective, in the ideal charging time Te, the drive module 12_1 can use the drive signals SD1 to SD5 to charge an electrically connected pixel. Outside the ideal charging time Te, the drive module 12_1 cannot use the drive signals SD1 to SD5 to charge an electrically connected pixel. It should be noted that, for the purpose of brief description, a rectangular wave is simply used to illustrate a waveform of each signal, to describe a time relationship. Whether a waveform distorts (distortion) after transmission is not discussed herein.

As shown in FIG. 2A, ideally, for signals received by a same pixel, the ideal drive signal SD_I should overlap with the sweep signal VG in a time sequence, to charge the pixel in the ideal charging time Te. The ideal charging time Te is equivalent to the pulse width of the sweep signal VG. However, actually, because of the transmission delay caused by the conductor D1, the actual drive signal SD transmitted to the pixel does not overlap with the sweep signal VG in time, or in other words, falls behind the sweep signal VG. In this embodiment, the actual drive signal SD falls behind the ideal drive signal SD_I by a transmission time delay Td. Therefore, the actual drive signal SD can charge an electrically connected pixel only in an actual charging time Tr. However, a time length of the actual charging time Tr is not larger than a time length of the ideal charging time Te. In this embodiment, a time length of the transmission time delay Td plus the time length of the actual charging time Tr is actually equal to the time length of the ideal charging time Te. The ideal charging time Te cannot be fully used, and in a worse scenario, mischarge may occur and consequently wrong data is written to the pixel.

Moreover, as shown in FIG. 2B, a longer cable segment causes more impact on a transmission time delay of the drive signal, and a shorter cable segment causes less impact on a transmission time delay of the drive signal. More specifically, in the embodiment shown in FIG. 1, a transmission time delay of the drive signal SD1 that is caused by the cable segment DF1 is larger than a transmission time delay of the drive signal SD2 that is caused by the cable segment DF2, the transmission time delay of the drive signal SD2 that is caused by the cable segment DF2 is larger than a transmission time delay of the drive signal SD3 that is caused by the cable segment DF3, a transmission time delay of the drive signal SD5 that is caused by the cable segment DF5 is larger than a transmission time delay of the drive signal SD4 that is caused by the cable segment DF4, and the transmission time delay of the drive signal SD4 that is caused by the cable segment DF4 is larger than the transmission time delay of the drive signal SD3 that is caused by the cable segment DF3. For ease of subsequent description, it is defined herein that both the cable segment DF1 and the cable segment DF5 correspond to the transmission time delay Td1, both the cable segment DF2 and the cable segment DF4 correspond to a transmission time delay. It can be learned from FIG. 2A and related descriptions that the transmission time delay affects the length of an actual charging time. As shown in FIG. 2B, because lengths of the cable segments are different, transmission time delays of drive signals are also different. Before the drive signal is not tuned, the drive signals charge a same column of pixels at different degrees, and consequently, brightness of the same column of pixels is different. Td2. However, actually, the transmission time delays are not necessarily equal.

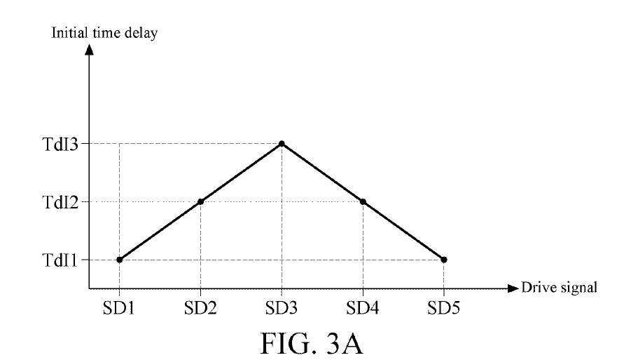

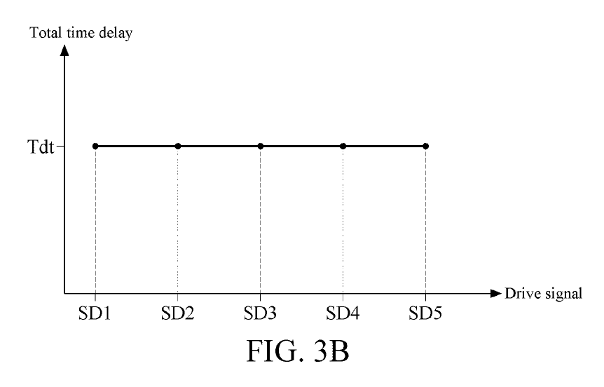

For an operation manner of the drive module, refer to both FIG. 3A and FIG. 3B. FIG. 3A is a schematic diagram of an initial time delay of each drive signal according to an embodiment of the present invention. FIG. 3B is a schematic diagram of a total time delay of drive signals according to the embodiment shown in FIG. 3A. In FIG. 3A, the x-axis corresponds to the cable segments DF1 to DF5 of the conductors D1 to D5 in FIG. 1, and the y-axis corresponds to initial time delays of the drive signals SD1 to SD5. In this embodiment, the drive module 12_1 respectively adjusts initial time delays of the drive signals. In this way, when a same column of pixels, for example, the pixels P1 to P5, are driven by a voltage level on the scanning line G1, the pixels can receive the corresponding drive signals SD1 to SD5 in a same actual charging time, to charge pixel electrodes in the pixels, and it is avoided that because of different lengths of the cable segments DF1 to DF5, written data cannot be smoothly updated for pixels P1 to P5 according to the corresponding drive signals SD1 to SD5. Alternatively, in another embodiment, sweep signals are further adjusted, so that the sweep signals and the drive signals can be aligned and overlapped.

In further details, when the drive module 12_1 respectively outputs the drive signals SD1 to SD5 to the cable segments DF1 to DF5, the drive signals SD1 to SD5 already have initial time delays. In this embodiment, the drive signal SD1 and the drive signal SD5 have an initial time delay TdI1, the drive signal SD2 and the drive signal SD4 have an initial time delay TdI2, and the drive signal SD3 has an initial time delay TdI3. Initial time delays TdI1 to TdI5 respectively correspond to the transmission time delays Td1 to Td5. From another perspective, a sum of the initial time delay TdI1 and the transmission time delay Td1 is equal to a sum of the initial time delay TdI2 and the transmission time delay Td2, and a sum of the initial time delay TdI2 and the transmission time delay Td2 is equal to a sum of the initial time delay TdI3 and the transmission time delay Td3. An analogy may be made below, and details are no longer described.

In other words, the drive signals have different initial time delays when initially being output by the drive module, and after passing through the corresponding cable segments during transmission, the drive signals further have corresponding transmission time delays in addition to the original initial time delays. Therefore, as shown in FIG. 3B, when the drive signal transmits through the cable segment and enters the connection segment, a total time delay of the drive signal is a sum of the initial time delay and the transmission time delay, and the drive signals have similar or same total time delays Tdt. In this embodiment, total time delays corresponding to the drive signals are equal, that is, a same column of pixels receive at a same time drive signals provided by a same drive module, and it is avoided that the pixels receive drive signals non-simultaneously because of different lengths of the cable segments. Therefore, sweep signals of scanning on-cables can cooperate with the drive signals having same total time delays, to smoothly write data to each pixel.

Actually, it may be set that sums of the initial time delays and the transmission time delays of the drive signals are the same or within a preset range. Related details may be defined by a person with ordinary skill in the art according to actual needs after reading this specification, and are not limited herein.

For a description of an operation manner of the drive module from another perspective, refer to FIG. 1 to FIG. 3B. From another perspective, there is a first time difference between the drive signal SD2 provided by the drive module 12_1 to the cable segment DF2 and the drive signal SD3 provided by the drive module 12_1 to the cable segment DF3. There is a second time difference between the drive signal SD3 provided by the drive module 12_1 to the cable segment DF3 and the drive signal SD4 provided by the drive module 12_1 to the cable segment DF4. The first time difference is different from the second time difference. The time difference herein is a difference between initial time delays of the drive signals, and similar to a time gradient, the time difference has a value and a direction. More specifically, as described above, the drive signal SD2 has the initial time delay TDI2, the drive signal SD3 has the initial time delay TDI3, and the drive signal SD4 has the initial time delay TDI2. The first time difference is obtained by subtracting the initial time delay TDI3 from the initial time delay TDI2, and the second time difference is obtained by subtracting the initial time delay TDI2 from the initial time delay TDI3.

Therefore, as shown in FIG. 3A, because the initial time delay TDI3 is larger than the initial time delay TDI2, and the initial time delay TDI2 is larger than the initial time delay TDI1, the first time difference is a negative number, and the second time difference is a positive number. Physically, when initially being output by the drive module12_1, the drive signal SD3 falls behind the drive signal SD2 in time, and the drive signal SD3 falls behind the drive signal SD4 in time. In another aspect, the drive signal SD3 falls behind the drive signal SD2, and the drive signal SD2 falls behind the drive signal SD1. However whether time differences between neighboring two signals are the same is not limited herein.

The drive module 12_1 is used as an example for description above, but the foregoing operation manner is also applicable to the drive module12_2 or another drive module further included in the display panel. As described above, the display panel actually may include more drive modules. Therefore, each drive module of the display panel can use the foregoing operation manner, and output drive signals having different initial time delays to corresponding conductors.

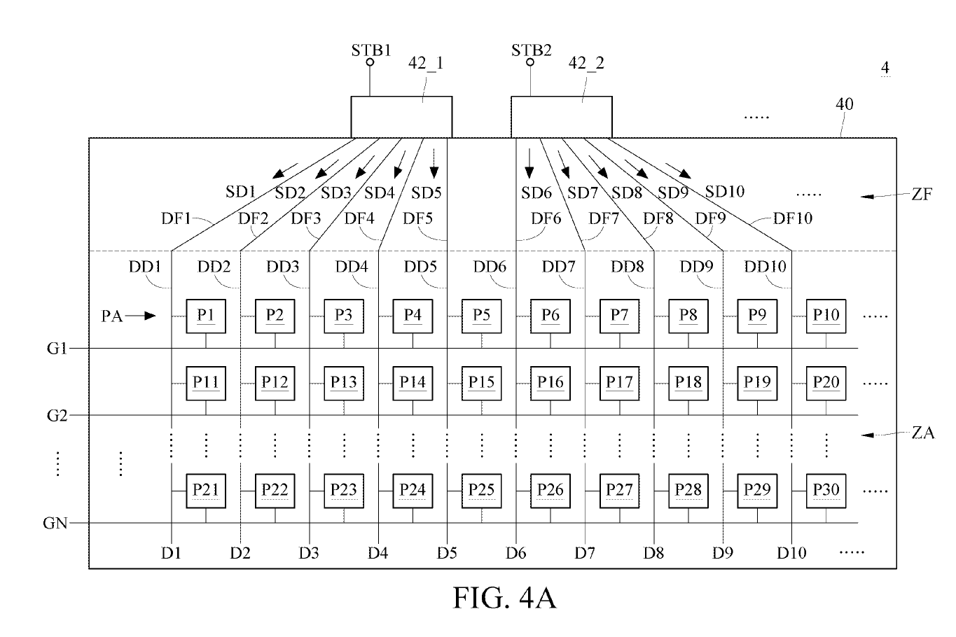

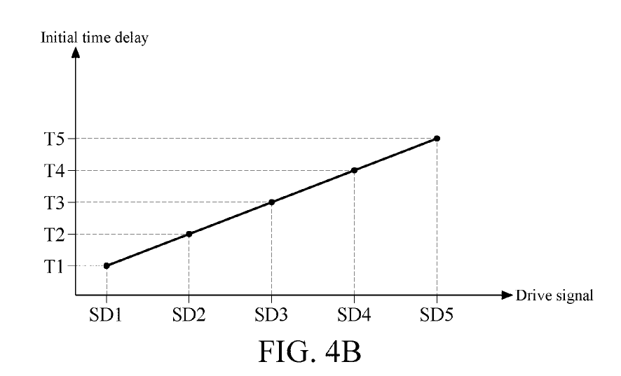

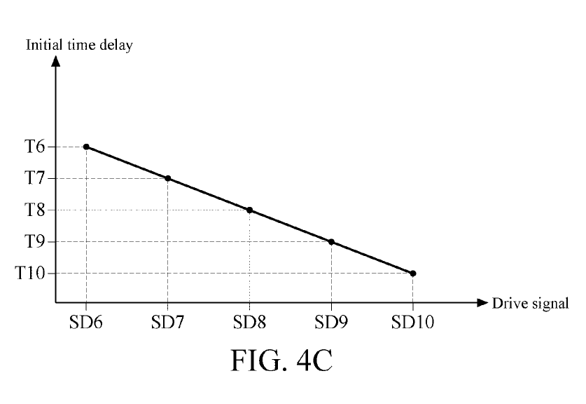

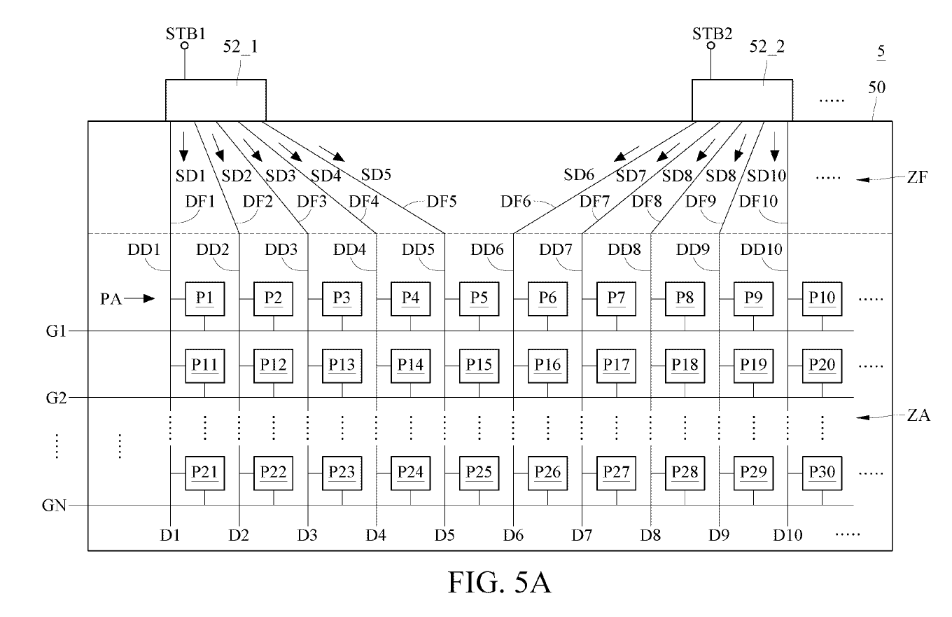

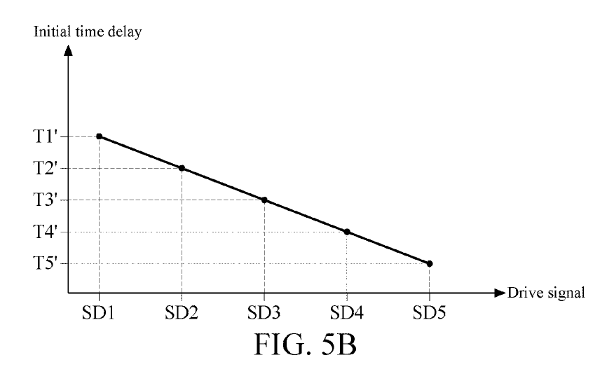

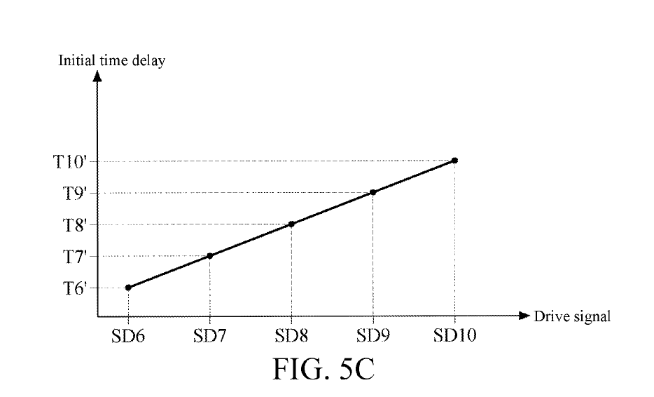

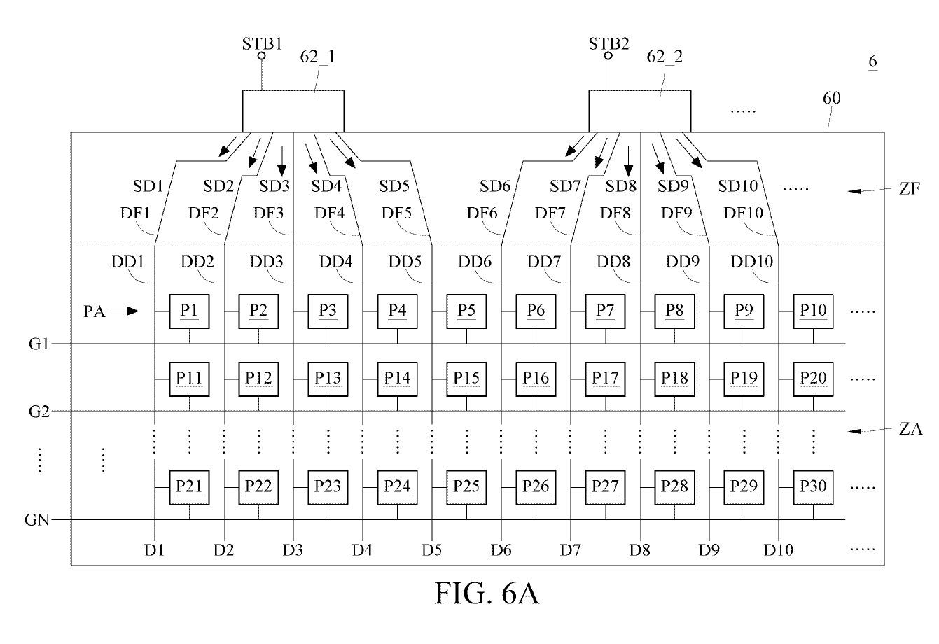

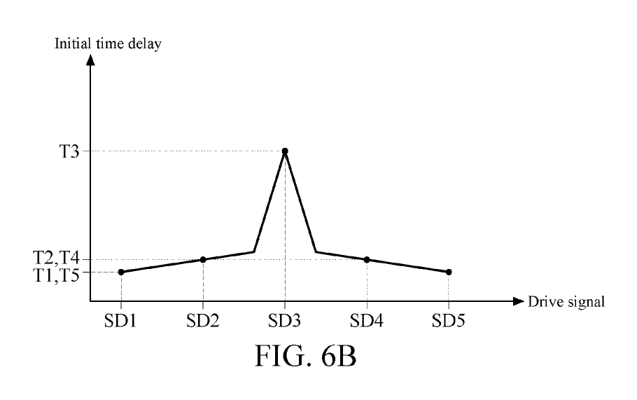

Next, refer to FIG. 4A and FIG. 6B. FIG. 4A is a schematic diagram of cables of a display panel according to another embodiment of the present invention. FIG. 4B is a schematic diagram of initial time delays of drive signals SD1 to SD5 in FIG. 4A. FIG. 4C is a schematic diagram of initial time delays of drive signals SD6 to SD10 in FIG. 4A. FIG. 5A is a schematic diagram of cables of a display panel according to still another embodiment of the present invention. FIG. 5B is a schematic diagram of initial time delays of drive signals SD1 to SD5 in FIG. 5A. FIG. 5C is a schematic diagram of initial time delays of drive signals SD6 to SD10 in FIG. 5A. FIG. 6A is a schematic diagram of cables of a display panel according to yet another embodiment of the present invention. FIG. 6B is a schematic diagram of initial time delays of drive signals SD1 to SD5 in FIG. 6A.

To be brief, FIG. 4A, FIG. 5A, and FIG. 6A show different cabling manners in the peripheral cable area ZF. Corresponding to FIG. 4A, drive modules 42_1 and 42_2 may enable output drive signals SD1 to SD10 to respectively have initial time delays T1 to T10 shown in FIGS. 4B and 4C, so that drive signals received by a same column of pixels have a same time sequence. Corresponding to FIG. 5A, drive modules 52_1 and 52_2 may enable output drive signals SD1 to SD10 to respectively have initial time delays T1′ to T10′ shown in FIGS. 5B and 5C, so that drive signals received by a same column of pixels have a same time sequence. Corresponding to FIG. 6A, a drive module 62_1 may enable output drive signals SD1 to SD5 to respectively have initial time delays T1′ to T5′ shown in FIG. 6B. Similarly, a drive module 62_2 may enable output drive signals SD6 to SD10 to respectively have initial time delays T1′ to T5′ shown in FIG. 6B, so that drive signals received by a same column of pixels have a same time sequence.

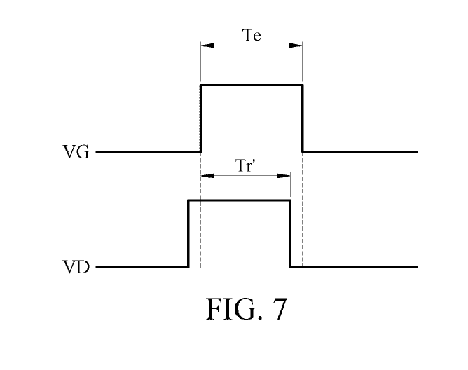

Actually, when the size of the display panel increases, a pixel may be wrongly charged because of a signal delay of a sweep signal. For descriptions, refer to both FIG. 1 and FIG. 7. FIG. 7 is a schematic diagram of a delay of a sweep signal according to an embodiment of the present invention. As shown in FIG. 1, a scanning line G1 to a scanning line GN are respectively connected to columns of pixels in the pixel array PA. Actually, a sweep signal is provided by a scanning line to a scanning on-cable from the left side, the right side, or both the left side and the right side of the figure. Therefore, a sweep signal received by a pixel relatively far away from a signal source, for example, a pixel P15 or a pixel P16 in FIG. 1, has a relatively large signal delay. As shown in FIG. 7, in this case, a sweep signal VG relatively falls behind a drive signal VD in time, and consequently the ideal charging time Te cannot be fully used, and a signal may be wrongly charged to a pixel. Actually, for the display panel, the foregoing operation manner of the drive module is also applicable to a related circuit for providing a sweep signal. Related details may be properly deduced by a person with ordinary skill in the art after reading this specification, and are no longer described in detail herein.

In conclusion, the present invention provides a display panel, where the display panel includes multiple drive modules. Each drive module is respectively electrically connected to multiple pixels in a display area by passing through multiple conductors. Lengths of some conductors are different. As signal time delays provided by the drive module to conductors are adjusted, the display panel can effectively overcome the problem that delays of cable signals are different because of different lengths of conductors. The drive modules provide signals having relatively short time delays to relatively long conductors, and provide signals having relatively long time delays to relatively short conductors. In this way, signals that are seen by receive ends, that is, pixels connected to the conductors, have a same time delay, and materials can be updated for each pixel within a similar operation time, to avoid the V block problem.

Although the embodiments of the present invention are disclosed above, the present invention is not limited thereto. Any modification and embellishment made without departing from the spirit and scope of the present invention shall fall within the patent protection scope of the present invention. For the protection scope of the present invention, refer to the appended patent application scope.

What is claimed is:

1. A display panel, comprising:
a substrate, having a display area and a peripheral cable area;
a pixel array, disposed in the display area, comprising a first plurality of pixels and a second plurality of pixels;
a plurality of conductors, comprising a first conductor and a second conductor, wherein said first conductor has a first length, said second conductor has a second length, and said first length and longer than said second length; and
a first drive module and a second drive module, located in the peripheral cable area, wherein each of said first drive module and said second drive module are respectively electrically connected to said first plurality of pixels and said second plurality of pixels via said plurality of conductors;
wherein said first drive module receives a first start signal, said second drive module receives a second start signal, and said first start signal is different from said second start signal;
where said first drive module provides a first drive signal with a first time delay relative to a reference time point and a second drive signal with a second time delay relative to said reference time point via said first conductor and said second conductor to said first plurality of pixels according to said first start signal, and said first time delay is less than said second time delay.

2. The display panel according to claim 1, wherein said first drive modules outputs to said conductors via M output ports, an N^{th} output port is located between an (N−1)^{th} output port and an (N+1)^{th} output port, a N^{th} drive signal provided by said first drive module by passing through the N^{th} output port has an N^{th} time delay relative to said reference time point, a (N+1)^{th} drive signal provided by said first drive module by passing through said (N+1)^{th} output port has an (N+1)^{th} time delay relative to said reference time point, a (N−1)^{th} drive signal provided by said first drive module by passing through the (N−1)^{th} output port has an (N−1)^{th} time delay relative to said reference time point; and
wherein said N^{th} time delay is larger than an (N−1)^{th} time delay, the N^{th} time delay is larger than an (N+1)^{th} time delay, M and N are positive integers, and N is larger than 1 and N is less than M.

3. The display panel according to claim 1, wherein an O^{th} time delay is larger than an (O−1)^{th} time delay, an (O+1)^{th} time delay is larger than the O^{th} time delay, a first difference between the O^{th} time delay and the (O−1)^{th} time delay is less than a second difference between the (O+1)^{th} time delay and O^{th} time delay, O is a positive integer, O−1, O, and O+1 is not larger than M, and O is not equal to M.

4. The display panel according to claim 1, wherein said first time delay and said second time delay are associated with pulse edges of said first start signal.

5. A display panel, comprising:
a substrate, having a display area and a peripheral cable area;
a pixel array, disposed in the display area, comprising a plurality of pixels;
a plurality of conductors, comprising a first conductor, a second conductor, and a third conductor, wherein said second conductor is located between said first conductor and said third conductor; and
a drive module, located in the peripheral cable area, wherein the drive module is respectively electrically connected to said plurality of pixels by passing through said plurality of conductors;
wherein the drive module provides a first drive signal, a second drive signal, and a third drive signal to said pixels via said first conductor, a second conductor, and a third drive signal respectively according to a start signal; and
wherein a first time difference is between said first drive signal and said second drive signal, a second time difference is between said second drive signal and said third drive signal, and the first time difference is different from the second time difference.

6. The display panel according to claim 5, wherein said drive module is respectively electrically connected to said conductors by using M output ports, an N^{th} output port is located between an (N−1)^{th} output port and an (N+1)^{th} output port, an N^{th} time difference is between a drive signal provided by the drive module by passing through the (N+1)^{th} output port and a drive signal of the N^{th} output port, an (N+1)^{th} time difference is between a drive signal provided by the drive module by passing through an (N+2)^{th} output port and a drive signal of the (N+1)^{th} output port, the N^{th} time difference is different from an (N+1)^{th} time difference, N is a positive integer, and N and N+1 are not larger than M.

7. The display panel according to claim 6, wherein the N^{th} time difference and the (N+1)^{th} time difference are respectively a positive number and a negative number.

8. The display panel according to claim 6, wherein an O^{th} time difference is different from an (O+1)^{th} time difference, the O^{th} time difference is less than the (O+1)^{th} time difference, O is a positive integer, O and O+1 are not larger than M, and O is not equal to N.

9. The display panel according to claim 6, wherein time delays of said first drive signal, said second drive signal, and said third drive signal are associated with pulse edges of said start signal.
